(19) United States
(12) Patent Application Publication
(10) Pub. No.: US 2026/0308349 A1
(43) Pub. Date: Oct. 8, 2026

(54) HYDROTHERMAL TREATMENT OF POLYMERS CONTAINING PERFLUROALKYL AND/OR HALOGENATED COMPOUNDS

(71) Applicant: Battelle Memorial Institute, Columbus, OH (US)

(72) Inventors: Albert DARLING, Columbus, OH (US); William R. HENSON, Columbus, OH (US); Jacob L. LILLY, Dublin, OH (US)

(21) Appl. No.: 19/460,621

(22) Filed: Jan. 27, 2026

Related U.S. Application Data
(60) Provisional application No. 63/749,809, filed on Jan. 27, 2025.

(51) Int. Cl. C08J 11/16; A62D 3/40; A62D 101/22

(52) U.S. Cl. CPC C08J 11/16; A62D 3/40; A62D 2101/22; C08J 2367/02

(57) ABSTRACT

The present invention relates to hydrothermal treatment of polymers that reduces or eliminates contaminants sourced from perfluroalkyl substances (PFAS) and/or halogen compound additives. The polymers can therefore be made to depolymerize and provide a relatively decontaminated source of recycled monomers. The output products of hydrothermal treatment may also be relied upon to promote bacterial growth.

### FIELD

The present invention relates to hydrothermal treatment of polymers that reduces or eliminates contaminants sourced from perfluroalkyl substances (PFAS) and/or halogen compound additives. The polymers can therefore be made to depolymerize and provide a relatively decontaminated source of recycled monomers. The output products of the hydrothermal treatment may also be utilized to promote bacterial growth.

### BACKGROUND

Perfluoroalkyl substances (PFAS) are known contaminants due to their relatively serious adverse health effects and long persistence in the environment. There is growing concern for end-of-life (EoL) synthetic materials/equipment that are polymeric based yet contaminated with PFAS which, if landfilled or incinerated, could leach PFAS into the environment or release aerosolized fluoro-compounds. In addition, there is also a growing concern regarding EoL polymeric based materials that are contaminated with halogen type compound additives, such as halogen compounds that provide flame-retardant characteristics.

Currently, solvents (such as butyl carbitol) and water washing can be utilized to remove some of the PFAS contamination before landfilling or incineration, but the PFAS still must be later destroyed in the rinse, and there is concern that this approach does not remove all the PFAS from the substrate.

Accordingly, there is a continuing need for processing protocols to recycle EoL polymeric based materials containing PFAS and/or halogen based contaminants, which reduces or eliminates the PFAS and/or halogen based components without the use of separate rinsing or extraction protocols.

### SUMMARY

A process for hydrothermal treatment of one or more polymers containing one or more perfluroalkyl substances and/or one or more halogen compounds comprising:
a. supplying one or more polymers containing an initial concentration of perfluroalkyl substances (I_{C-PFAS}) and/or an initial concentration of one or more halogen compounds (I_{C-Halogen}):
b. hydrothermal processing of said one or more polymers in aqueous media under pressure and basic conditions;
c. depolymerizing said one or more polymers to one or more monomers; and
   i. forming a reduced concentration of said one or more perfluroalkyl substances (R_{C-PFAS}) in said one or more monomers wherein R_{C-PFAS}<I_{C-PFAS}; and/or
   ii. forming a reduced concentration of said one or more halogen compounds in said one or more monomers (R_{C-Halogen}) wherein R_{C-Halogen}<I_{C-Halogen}.

In addition, the output products of the hydrothermal treatment of the one or more polymers containing an initial concentration of perfluroalkyl substances may be relied upon to promote bacterial growth.

### FIGURES

FIG. 1 is a plot showing solids yield and terephthalic acid (TPA) yield for the identified samples.

FIG. 2 is a plot showing an evaluation of the reaction products versus reaction duration analyzed by liquid chromatograph/mass spectroscopy (LC-MS).

FIG. 3 is a plot of bacterial growth versus time for the output products of hydrothermal processing of the indicated samples versus supercritical water oxidation.

### DETAILED DESCRIPTION OF PREFERRED EMBODIMENTS

The present invention relates to hydrothermal processing of one or more polymers containing one or more perfluoroalkyl substances (PFAS) and/or one or more halogenated compound additives. It is contemplated that the polymers include either synthetic or natural polymer materials. Synthetic polymers may include polyesters and polyamides and in particular aromatic polyesters such as poly(ethylene terephthalate) or PET. Natural polymers may include cotton which relies on the presence of cellulose.

The process is preferably conducted in aqueous media under pressure and in basic conditions, more preferably at a pH of greater than 9.0, or even more preferably in the range of 9.0-13.0. The process is also conducted at elevated temperature and pressure, such as preferably in the temperature in the range of 250° C. to 500° C. and preferably at a pressure in the range of 500 psi to 2500 psi. Reference to hydrothermal is therefore reference to heating in the presence of water.

As a result of such hydrothermal treatment, depolymerization of the polymer occurs, resulting in recovery of 50% or more by weight of the monomer(s) originally utilized for the formation of the one or more polymers undergoing hydrothermal treatment. Preferably 75% by weight or more or most preferably 85% by weight or more of the monomer(s) are recovered. In addition, at the same time, the level of PFAS and/or halogenated compound additives, such as bromine or chlorine compounds, are reduced or eliminated, thereby providing a relatively decontaminated monomer feedstock for recycling purposes.

Namely, at the same time of depolymerization, the initial concentration of the one or more PFAS initially present in the one or more polymers undergoing hydrothermal treatment (I_{C-PFAS}) is reduced in the recovered monomer(s) to a level of preferably less than or equal to 1.0 wt. %, more preferably ≤0.5%, or even more preferably, ≤0.2%, or ≤0.1%. Similarly, at the same time of depolymerization, the initial concentration of one or more of the halogenated compound additive (IC-Halogen) is also preferably reduced in the recovered monomer(s) to a level of less than or equal to 1.0 wt. %, more preferably ≤0.5%, or even more preferably, <0.2%, or ≤0.1%. Accordingly, it can be appreciated that polymers herein can be depolymerized and the level of PFAS and/or halogen contaminants present in the recovered monomer(s) are also simultaneously reduced. The reduced concentration of PFAS in the recovered monomer(s) may be identified as (R_{C-PFAS}) and the reduced concentration of the halogen compound in the recovered monomer(s) may be identified as (R_{C-Halogen}), wherein R_{C-PFAS}<I_{C-PFAS} and R_{C-Halogen}<I_{C-Halogen}.

As noted, the above hydrothermal processing of one or more polymers containing PFAS and/or halogen compound additives is contemplated to be particularly applicable to any synthetic and/or natural polymer or mixture of polymers that contain contaminants such as PFAS and/or halogen compound additives. This may include, but is not limited to, e.g., weatherproofed textiles that have PFAS water barrier coatings such as military uniforms and tenting fabrics, along with firefighting gear that is contaminated with PFAS-containing aqueous film forming foams (AFFFs), as well as hoses and tank liners also coated with AFFFs. It also includes polyolefin type film material, and by way of further example, HDPE carboy chemical containers lined with PFAS coatings for chemical resistance.

### WORKING EXAMPLES

Depolymerization And Breakdown Of PFAS: Hydrothermal processing at basic conditions was shown to allow for the simultaneous breakdown of PFAS compounds and depolymerization of a polyester-based textile. This then allowed for the recycling of polyester and reduction or elimination of their PFAS coating in a single-processing protocol.

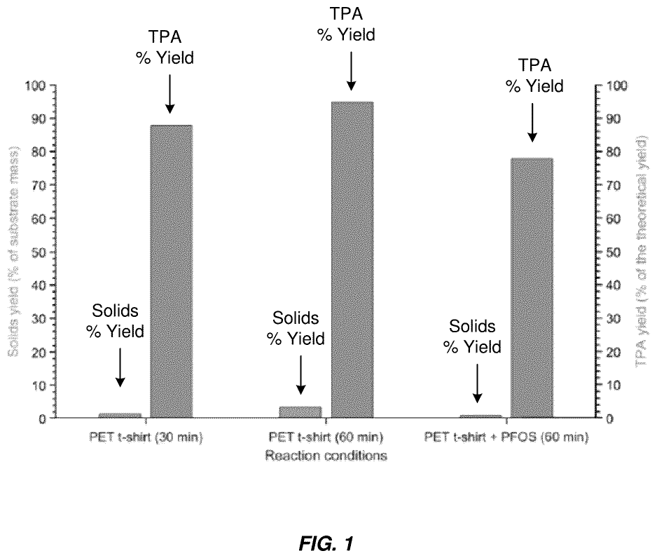

White polyester t-shirts and perfluooctanesulfonic acid (PFOS), a PFAS compound utilized in commercial fabric protectors, were heated at 350° C. in a 2.5 M NaOH solution in a high-pressure autoclave for 60 minutes. Under these reaction conditions, it was observed that the polyester was depolymerized to sodium terephthalate and ethylene glycol. Post reaction conversion of the sodium terephthalate to terephthalic acid (TPA) was accomplished via acidification with concentrated HCl leading to TPA in 77.9% yield. See FIG. 1 which shows: (1) the solids yield and TPA yield for hydrothermal treatment of the PET t-shirt for 30 minutes; (2) the solids yield and TPA yield for hydrothermal treatment of the PET t-shirt for 60 minutes, and (3) the solids yield and TPA yield for hydrothermal treatment of the PET t-shire containing PFOS after 60 minutes.

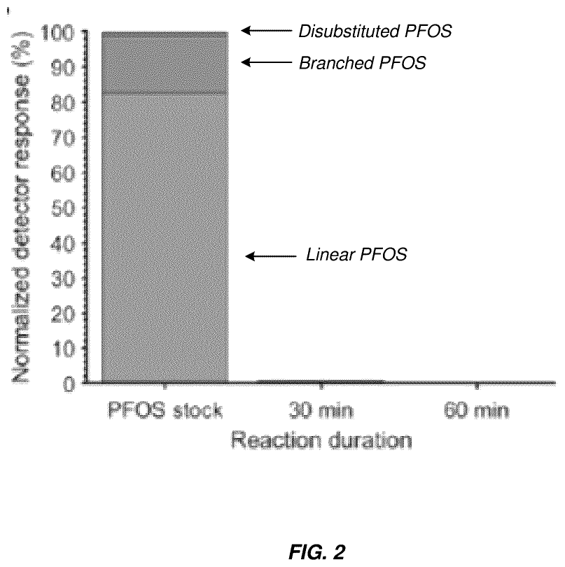

Evaluation of the concentration of PFOS post-hydrothermal processing at 350° C. in 2. 5M NaOH demonstrated significant breakdown of PFOS, after both 30 minutes and 60 minutes. See FIG. 2 which shows the reaction products analyzed by LC-MS. This technique allowed for the differentiation between linear, branched and disubstituted forms of PFOS, present in the analyzed stock solution. The respond provided by the LC-MS detector for PFOS samples processed for 30 and 60 minutes resulted in only 0.79% and 0.25% of the intensity of the signal of the original stock solution. These results indicate that there is a significant breakdown of the PFOS after 30 minutes of hydrothermal treatment and increasing the time period of hydrothermal treatment to 60 minutes allows for a further increase in PFOS breakdown.

Hydrothermal Breakdown of Halogen Compound Additives: Tetrabromobisphenol A (TBBPA), a common flame retardant additive, was hydrothermally decomposed in 2.5M NaOH via heating in a high-pressure stainless steel reactor at 250° C. for 2 hours. To prepare the reaction contents for LC-MS characterization the following preparation were made: the reaction contents were poured into a jar (aqueous fraction) and the residual reaction contents were collected with acetone and poured into a separate jar (acetone fraction 1). Organic-soluble products were then extracted from the aqueous soluble fraction into chloroform. The chloroform was then removed via evaporation and the organic products were redissolved in acetone (fraction 2).

Following LC-MS analysis both acetone fraction 1 and acetone fraction 2 did not show any detectable amounts of TBBPA. Additionally, TBBPA cannot be detected in the aqueous fraction due to the instability of TBBPA in water. As TBBPA was not detected in any of the samples, the extent of breakdown, determined by the 1 μg/ml limit of detection (LOD) of the submitted LC-MS samples for TBBPA, was >99.9% breakdown. Bromide ion selective electrode analysis of the aqueous fraction indicates that a significant amount of bromine from TBBPA was converted to bromide as 61% of the theoretical yield of bromide was observed in the aqueous fraction. The remaining bromine may be accounted for through mass loss during the reaction work-up process or through breakdown of TBBPA to relatively smaller organohalides instead of complete dehalogenation to form bromide.

As may be appreciated, it has been demonstrated that hydrothermal treatment of polymers reduces or eliminates contaminants sourced from perfluoroalkyl substances (PFAS) and/or halogen compound additives. The polymers can be made to depolymerize and provide a relatively decontaminated source of recycled monomers. The hydrothermal treatment is therefore effective for both PFAS and/or halogen compound reduction or elimination but suitable to enable depolymerization and recover of relatively uncontaminated monomer(s) suitable for reuse.

The hydrothermal approach is therefore contemplated to provide one or more benefits. The recycling of PFAS-free and/or halogen-free chemical from EoL polymer materials is contemplated to offset the additional cost of destruction and enable a more circular model to reduce the quantity of such contaminants otherwise present in landfills. Reducing or eliminating PFAS and/or halogen directly on EoL polymer materials without rinsing or extraction will necessarily reduce the liquid volume that has to be treated, which also reduces destruction costs as well as the logistical burdens in transporting or field-processing of liquid volumes.

The present invention has further recognized that the output products of the process herein for hydrothermal treatment of the one or more polymers containing one or more perfluroalkyl substances, can be uniquely employed to promote bacterial growth. Preferably, the method for promoting bacterial growth is as follows: (1) provide one or more polymers containing an initial concentration of perfluroalkyl substances (I_{C-PFAS}); (2) hydrothermal processing of said one or more polymers containing an initial concentration of perfluroalkyl substances (I_{C-PFAS}) in aqueous media under pressure and basic conditions; (3) depolymerizing said one or more polymers to one or more monomers and forming a reduced concentration of said one or more perfluroalkyl substances (R_{C-PFAS}) in said one or more monomers wherein R_{C-PFAS}<I_{C-PFAS}; (3) providing said one or more monomers and said reduced concentration of perfluroalkyl substances to bacteria and promoting bacterial growth.

Attention is directed to Table 1 below which identifies the application of hydrothermal treatment and supercritical water oxidation treatment of the identified polyester samples as well as polyester samples containing perfluooctanesulfonic acid (PFOS). Hydrothermal treatment refers to the hydrothermal processing of the polymer containing an initial concentration of PFA as described herein. Supercritical water oxidation is reference to the use of relatively high temperature (>374° C.) and pressures (>221 bar) which is typically relied upon to destroy hazardous chemical contaminants, such as PFOS in water.

TABLE 1
Samples And Conditions For Bacterial Growth Evaluation

| Sample | Substrate(s) | Reaction Conditions |
|---|---|---|
| 1 | White Polyester | Hydrothermal Treatment |
| 2 | White Polyester | Supercritical Water Oxidation |
| 3 | White Polyester + PFOS | Hydrothermal Treatment |
| 4 | White Polyester + PFOS | Supercritical Water Oxidation |

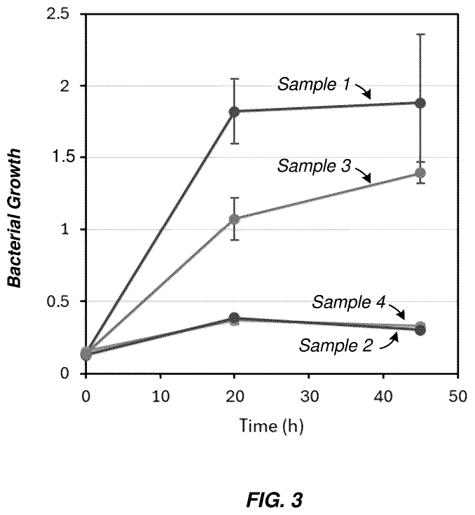

Attention is next directed to FIG. 3 which plots the growth of a representative bacteria, Halamonas, in units of optical density versus time, for the alkaline hydrothermal treatment products (monomer and reduced concentration of the PFOS) and the products of supercritical water oxidation. As can be seen for Sample 3, alkaline hydrothermal treatment of polyester and PFOS provide output products (monomer and reduced concentration of PFOS) that allowed for bacterial growth. By contrast, the output products of supercritical water oxidation indicate relative low bacterial growth. Accordingly, the output products of hydrothermal treatment of polymeric material containing perfluroalkyl substances can now be utilized to promote bacterial growth.

1. A process for hydrothermal treatment of one or more polymers containing one or more perfluroalkyl substances and/or one or more halogen compounds comprising:
a. supplying one or more polymers containing an initial concentration of perfluroalkyl substances (I_{C-PFAS}) and/or an initial concentration of one or more halogen compounds (I_{C-Halogen}):
b. hydrothermal processing of said one or more polymers in aqueous media under pressure with heating in basic conditions;
c. depolymerizing said one or more polymers to one or more monomers; and
i. forming a reduced concentration of said one or more perfluroalkyl substances in said one or more monomers (R_{C-PFAS}) wherein R_{C-PFAS}<I_{C-PFAS}; and/or
ii. forming a reduced concentration of said one or more halogen compounds in said one or more monomers (R_{C-Halogen}) wherein R_{C-Halogen}<I_{C-Halogen}.

2. The method of claim 1 wherein said hydrothermal conditions comprise heating said one or more polymers in said aqueous media at a pH of greater than 9.0.

3. The method of claim 1 wherein said hydrothermal condition comprise heating said one or more polymer in said aqueous media at a temperature of 250° C. to 500° C.

4. The method of claim 1 wherein said pressure is in the range of 500 psi to 2500 psi.

5. The method of claim 1 wherein said depolymerization provides 50% by more by weight recovery of monomer(s) utilized for the formation of said one or more polymers undergoing hydrothermal processing.

6. The method of claim 5 wherein said reduced concentration of PFAS in said recovered one or more monomers (R_{C-PFAS}) is less than or equal to 1.0 wt. %.

7. The method of claim 5 wherein said reduced concentration of halogen compound in said recovered one or more monomers (R_{C-Halogen}) is less than or equal to 1.0 wt. %.

8. The method of claim 1 wherein said one or more polymers comprises a polyester.

9. The method of claim 1 wherein said one or more polymers comprises a textile.

10. The method of claim 1 wherein said one or more polymers comprises a polymeric hose.

11. The method of claim 1 wherein said one or more polymers comprises a polymeric film material.

12. The method of claim 1, wherein step (a) comprises supplying one or more polymers containing an initial concentration of perfluroalkyl substances (I_{C-PFAS}) and step (c) comprises depolymerizing said one or more polymers to one or more monomers and forming a reduced concentration of said one or more perfluroalkyl substances in said one or more monomers (R_{C-PFAS}) wherein R_{C-PFAS}<I_{C-PFAS} further providing said one or more monomers and said reduced concentration of perfluroalkyl substances to bacteria and promoting bacterial growth.

13. A process for hydrothermal treatment of one or more polymers containing one or more perfluroalkyl substances and/or one or more halogen compounds comprising:
a. supplying one or more polymers containing an initial concentration of perfluroalkyl substances (I_{C-PFAS}) and/or an initial concentration of one or more halogen compounds (I_{C-Halogen}):
b. hydrothermal processing of said one or more polymers in aqueous media under pressure with heating in basic conditions;
c. depolymerizing said one or more polymers to one or more monomers; and forming a reduced concentration of said one or more perfluroalkyl substances in said one or more monomers (R_{C-PFAS}) wherein R_{C-PFAS}<I_{C-PFAS}.

14. The method of claim 13 wherein said hydrothermal conditions comprise heating said one or more polymers in said aqueous media at a pH of greater than 9.0.

15. The method of claim 13 wherein said hydrothermal condition comprise heating said one or more polymer in said aqueous media at a temperature of 250° C. to 500° C.

16. The method of claim 13 wherein said pressure is in the range of 500 psi to 2500 psi.

17. The method of claim 13 wherein said depolymerization provides 50% by more by weight recovery of monomer(s) utilized for the formation of said one or more polymers undergoing hydrothermal processing.

18. The method of claim 17 wherein said reduced concentration of PFAS in said recovered one or more monomers (R_{C-PFAS}) is less than or equal to 1.0 wt. %.

19. The method of claim 1 wherein said one or more polymers comprises a polyester.

20. The method of claim 1 wherein said one or more polymers comprises a textile.

21. The method of claim 1 wherein said one or more polymers comprises a polymeric hose.

22. The method of claim 1 wherein said one or more polymers comprises a polymeric film material.

23. The method of claim 13 claim wherein step (a) comprises supplying one or more polymers containing an initial concentration of perfluroalkyl substances (I_{C-PFAS}) and step (c) comprises depolymerizing said one or more polymers to one or more monomers and forming a reduced concentration of said one or more perfluroalkyl substances in said one or more monomers (R_{C-PFAS}) wherein R_{C-PFAS}<I_{C-PFAS} further providing said one or more monomers and said reduced concentration of perfluroalkyl substances to bacteria and promoting bacterial growth.
